(19) United States
(12) Patent Application Publication
(10) Pub. No.: US 2007/0041560 A1
(43) Pub. Date: Feb. 22, 2007

(54) System and method for managing memberships over a network

(75) Inventor: Suzanne E. Turcotte, Providence, RI (US)

Correspondence Address: EDWARDS & ANGELL, LLP, P.O. BOX 55874, BOSTON, MA, 02205, US

(73) Assignee: One Good Call, Inc., Lafayette, CO (US)

(21) Appl. No.: 11/437,348

(22) Filed: May 19, 2006

Related U.S. Application Data
(60) Provisional application No. 60/683,265, filed on May 20, 2005.

(51) Int. Cl. H04M 7/00

(52) U.S. Cl. 379/230

(57) ABSTRACT

A method of applying for or renewing a subscription or membership over a telecommunication network, where the steps of the method include establishing communication between a calling subscriber/member and a business offering the subscription or membership or a third party verifying the identity of the subscriber/member providing the subscriber/member with a plurality of subscription or renewal options from which said subscriber/member must choose a preferred subscription or renewal option and processing the subscriber/member's preferred subscription or renewal option.

### CROSS-REFERENCE TO RELATED APPLICATION

This application claims priority to U.S. Provisional Patent Application No. 60/683,265, filed May 20, 2005, which is incorporated herein by reference. This application also related to U.S. Utility Patent Application No. 11/365,568, which is incorporated herein by reference.

### BACKGROUND OF THE INVENTION

1. Field of the Invention

The present technology relates, in general, to providing and managing a telecommunication system that allows for applying for and/or renewing subscriptions, membership, and the like using a subscriber's or member's telecommunication device. Particularly, the present technology relates to software, systems, and methods that allow a subscriber, member or the like to apply for and/or renew, respectively, his or her subscription or membership electronically over a network, e.g., a public switched telephone network or the Internet, using the subscriber's or member's telecommunication device and, further, to recording such events or transactions in an accessible and updateable database.

In addition, the present technology relates to systems and methods that integrate calling technology, data entry, and data downloading via a telecommunication device and a telecommunication network in such a way that the member or subscriber can call an identified number or, alternatively, be called by the identified number, and automatically apply for and/or renew, for example a subscription, a membership, and the like and, moreover, the cost of the renewal can appear on the subscriber's or member's next telephone billing statement or other billing statement.

2. Background of the Relevant Art

Businesses and other organizations, e.g., magazine publishers, newspaper publishers, health clubs, periodic book clubs, non-profit organizations, political action committees, political parties, and the like, that rely on the sale of subscriptions or memberships for their profitability or continued existence necessarily rely on the continued subscriptions or membership of their current clientele. As such, these businesses and other organizations expend great deals of time and money to attract new subscribers or members and to encourage their subscribers and members to renew their, respective, subscriptions or memberships. For example, magazine publishers and health clubs are typically proactive and begin mailing renewal letters soon after a new subscription or membership has begun; often offering an extension of a current subscription or membership at a discounted rate. Newspaper publishers and periodic book clubs are typically reactive, assuming that a subscription or membership is indefinite until canceled by the subscriber or member. As a result, newspaper publishers and periodic book clubs begin mailing offers to encourage former clientele to re-subscribe or rejoin at a discounted rate or with the inclusion of a free gift.

Businesses also must devote capital, labor, and other resources to invoice their subscribers/members and to process each payment. As a result, for a $20 renewed subscription, the business may outlay several dollars, drastically reducing the net profit.

At the subscriber/member end of this process, many people are annoyed by the endless stream of membership or subscription offers, renewal letters or evening telephone calls that they must endure. The offers and renewal letters must be read and/or thrown away. The telephone calls: politely ended, or not. For those subscribers/members who wish to subscribe or join a club and to renew their subscriptions or memberships, a process that is simple and easy to complete is preferable.

### SUMMARY OF TH INVENTION

In view of the above, it would be desirable to provide systems and methods to facilitate application for and/or renewal of subscriptions, memberships, and the like. Preferably, it would be desirable to provide systems and methods that allow initiation of the application and/or renewal process at either the business or organization end or at the subscriber/member end. More preferably, it would be desirable to provide systems and methods that would permit the application for and/or renewal of subscriptions, memberships, and the like using a telecommunication device and a telecommunication network. Most preferably, it would be desirable to provide systems and methods that would permit the application for and/or renewal of subscriptions and memberships that require the manipulation of a few keys or push buttons or the repetition of a few words using an interactive voice recording (“IVR”) system. Even more preferably, it would be desirable to invoice new or continuing subscribers and members using the subscriber's or member's monthly billing statement for their local or long distance telephone carrier to reduce the business overhead to invoice and process payments from a multiplicity of subscribers and members.

In a first embodiment, the present technology provides methods of applying for or renewing a subscription or membership over a telecommunication network, the steps of the method including establishing communication between a calling subscriber/member and a business offering the subscription or membership or a third party, verifying the identity of the subscriber/member, providing the subscriber/member with a plurality of options for applying for or renewing said subscription or membership from which said subscriber/member must choose a preferred subscription or renewal option and processing the subscriber/member's preferred subscription or renewal option.

Preferably, the step of processing the subscriber/member's preferred subscription or renewal option includes, respectively, recording or updating an expiration date of the subscriber/member's subscription or membership. More preferably, the step of processing the subscriber/member's preferred subscription or renewal option includes providing the subscriber/member with an invoice in an amount of the subscription or renewal. Most preferably, the step of providing the subscriber/member with an invoice comprises including the amount of the subscription or renewal on a monthly billing statement from a local or long distance telephone carrier used by the subscriber/member.

In a second embodiment, the present technology provides methods of applying for or renewing a subscription or membership over a telecommunication network, the steps of the method including establishing communication between a calling business offering the subscription or membership or a third party and a subscriber/member, verifying the identity of the subscriber/member providing the subscriber/member with a plurality of options for subscribing to or renewing said subscription or membership from which said subscriber/member must choose a preferred subscription or renewal option and processing the subscriber/member's preferred subscription or renewal option.

Preferably, the step of processing the subscriber/member's preferred subscription or renewal option includes recording or updating an expiration date of the subscriber/member's subscription or membership. More preferably, the step of processing the subscriber/member's preferred subscription or renewal option includes providing the subscriber/member with an invoice in an amount of the renewal. Most preferably, the step of providing the subscriber/member with an invoice comprises including the amount of the subscription or renewal on a monthly billing statement from a local or long distance telephone carrier used by the subscriber/member.

In a third embodiment, the present technology provides systems for subscribing or renewing subscriptions or memberships over a telecommunication network, wherein the system includes a means for verifying the identification of a calling subscriber/member an interactive voice recording system on the telecommunication network that provides one or more subscription or membership application or renewal options and a processing means to processes one or more subscription or membership application or renewal option entries entered by the subscriber/member using a telecommunication device.

Preferably, the processing means of the embodied systems includes means to record or update an expiration date of the subscriber/member's subscription or membership. More preferably, the processing means provides the subscriber/member with an invoice in an amount of the subscription or renewal. Most preferably, the processing means provides the invoice for the amount of the subscription or renewal on a monthly billing statement from a local or long distance telephone carrier used by the subscriber/member.

It should be appreciated that the present technology can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

The present technology will be better understood by reference to the following more detailed description and accompanying drawings where like reference numbers refer to like parts:

FIGS. 1a and 1b provide a flow chart of an illustrative embodiment of a method for applying for or renewing memberships/subscriptions via a telecommunication network in which the subscriber/member initiates the call in accordance with the present invention;

FIGS. 2a and 2b provide a flow chart of another illustrative embodiment of a method for applying for or renewing memberships/subscriptions via a telecommunication network in which the business initiates the call in accordance with the present invention; and

FIG. 3 is a block diagram of an illustrative embodiment of a system for applying for or renewing memberships/subscriptions via a telecommunication network in accordance with the present invention.

### DETAILED DESCRIPTION OF PREFERRED EMBODIMENTS

The present technology provides systems and methods for applying for and/or renewing a subscription or a membership using a telecommunication device, e.g., a telephone, over a telecommunication network, e.g., a public switched telephone network (“PSTN”). Although only three embodiments of the present invention will be presented in this disclosure, the invention is not to be construed as being so limited. Rather, the three embodiments are provided illustratively to show specific usage and applications of the invention. Those skilled in the art would be able to apply the teachings of the embodiments of this disclosure to a myriad of systems and methods, all of which are within the scope and spirit of this disclosure.

In a first embodiment, the present technology provides methods for applying for or renewing a subscription or a membership using a telecommunication device, e.g., a telephone, over a telecommunication network, e.g., a PSTN. In the description of this first embodiment, we will assume that the subscriber or member (hereinafter “subscriber/member”) initiates the communication link, e.g., the telephone call, to the business or other organization (hereinafter “business”) for the purpose of renewing an existing subscription. Those of ordinary skill in the art will appreciate that the disclosed methods can be easily adapted to a situation in which the business establishes the communication link with the subscriber/member or a caller calls to apply for a new subscription or membership.

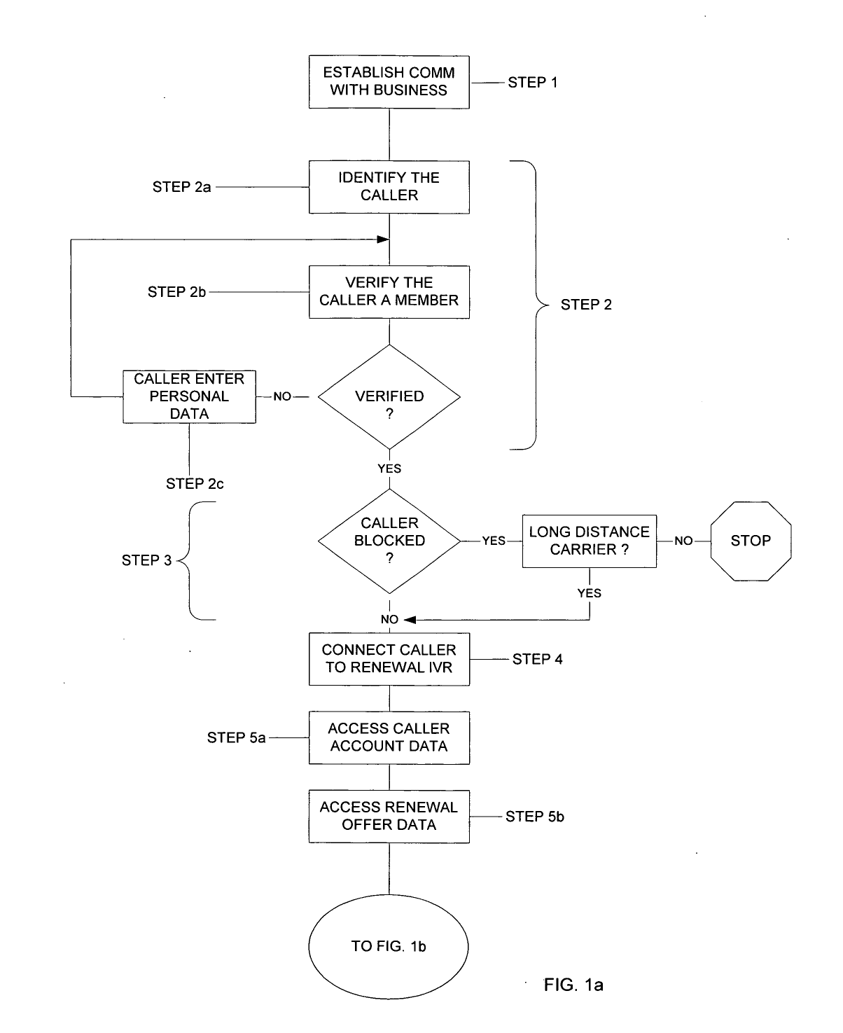

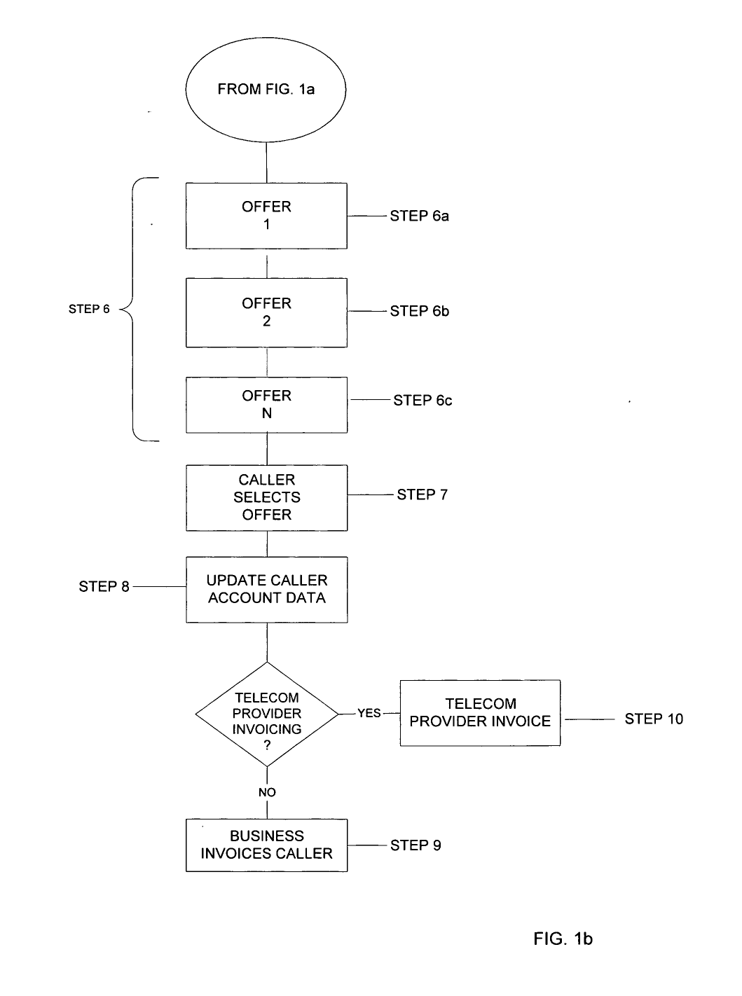

Referring to FIGS. 1a and 1b, there is shown an illustrative embodiment of a method for renewing a subscription or a membership using a telecommunication device, e.g., a telephone, over a telecommunication network, e.g., a PSTN. In a first step, the subscriber/member establishes communication with the business system (STEP 1), e.g., by calling a pre-designated telephone number that has been made known to the subscriber/member through advertising, a letter, a flyer, an electronic mail message, and the like. Preferably, the subscriber/member can establish a communication link with the business using a hardwired or wireless telephone. More preferably, the subscriber/member can establish a communication link with the business over a PSTN. Although this disclosure will refer to the subscriber/member calling a business, in the alternative, the subscriber/member can call a third party that is being used by the business to perform the following steps of the process. Accordingly, hereinafter reference to the “business” will also include, without limitation, reference to a third party providing the services in the business' behalf.

Once the subscriber/member has established a communication link (STEP 1), the business must identify the caller and verify that the caller is a subscriber/member of the business (STEP 2). Preferably, a local or remote microprocessor is also in communication with the designated telephone number of the business. More preferably, the microprocessor includes a plurality of applications, e.g., software and/or executable programs, that can identify the telephone number from which the call originated (STEP 2a) and compare the origination telephone number with a database of subscriber/member telephone numbers (STEP 2b). If the origination telephone number does not coincide with any subscriber/member telephone numbers in the database then the call can be terminated. Preferably, the call will be terminated in conjunction with a voice recording alerting the caller that the origination telephone number is not registered and that the transaction cannot be completed. More preferably, the microprocessor can execute another application to initiate an interactive voice recording (“IVR”) requesting the subscriber/member to enter some personal information about himself or herself (STEP 2c), i.e., one or more of the spelling the subscriber/member's last name, all or some portion of the subscriber/member's social security number, a personal identification number, the subscriber/member's zip code, and the like, to identify the caller as a subscriber/member (STEP 2b). Preferably, this information can be input manually using the telephone keypad or by vocally responding to the IVR options.

Having verified that the caller is a subscriber/member (STEP 2b) either through the origination telephone number or by using some other information provided by the subscriber/member, the business can ascertain whether or not the subscriber/member is included on a database of subscriber/members who the business has or wants to block from renewing a membership (STEP 3). Preferably, the microprocessor can execute an application that can access a database containing a list of subscriber/member's whose continued subscription or membership, for whatever reason, may no longer be desired by the business. As will be described in greater detail below, one reason for blocking a subscriber/member's telephone number is that the subscriber/member's local or long distance telephone carrier will not include the cost of any renewal in the subscriber/member's monthly telephone billing statement. Although this embodiment of the present technology refers to the subscriber/member and his or her local or long distance telephone carrier, the invention is not to be construed as being limited thereto. Indeed, for invoicing purposes, the cost for applying for or renewing a subscription of membership can appear on any billing means that invoices subscribers/members periodically, e.g., Internet Service Providers, cable providers, and the like.

If the subscriber/member is blocked from renewal for a reason other than his or her local or long distance telephone carrier will not include the renewal fees on the subscriber/member's monthly telephone billing statement, then the call can be terminated. Preferably, the call will be terminated in conjunction with a voice recording alerting the caller that renewal of his or her subscription or membership is not authorized, further providing a customer service number that the subscriber/member can call for more information. Alternatively, an IVR message can alert the caller that renewal of his or her subscription or membership is not authorized, but allow the subscriber/member to be transferred directly to a customer service representative, e.g., by pressing a designated key on the telephone key pad or by repeating a designated number. If the subscriber/customer presses the designated key or speaks the designated number, then another application in the microprocessor can connect the subscriber/member to a customer service representative who is located at a local or remote location. Preferably, connection with a customer service representative is by PSTN, wide area net (“WAN”), local area net (“LAN”), Internet, wireless communication, T1, T2, and the like.

Having verified that the caller is a subscriber/member (STEP 2) and that the subscriber/member is not blocked from renewing his or her subscription or membership for a reason other than his or her local or long distance telephone carrier will not include the renewal fees on the subscriber/member's monthly telephone bill (STEP 3), then the microprocessor can execute another application that will connect the subscriber/member to a subscription or membership renewal IVR (STEP 4). Thus, if the subscriber/member is blocked earlier because his or her local or long distance telephone carrier will not include the renewal fees on the subscriber/member's monthly telephone billing statement, preferably, the microprocessor can execute another application that will connect the subscriber/member to a subscription or membership renewal IVR (STEP 4).

Preferably, the application can access a database containing information about the subscriber/member's account, e.g., expiration date of the subscription or membership, address, personal information, and the like (STEP 5a). More preferably, the application can access a database that contains information about offers and discounts that the subscriber/member may be entitled to (STEP 5b).

In a next step, the IVR can provide any number of options to the subscriber/member (STEPS 6a-6c). For example, the IVR could request that the subscriber/member “PRESS OR SAY ONE IF YOU WANT TO RENEW YOUR SUBSCRIPTION/MEMBERSHIP FOR ONE YEAR FOR $100” (STEP 6a); or “PRESS OR SAY TWO IF YOU WANT TO RENEW YOUR SUBSCRIPTION/MEMBERSHIP FOR TWO YEARS FOR $150” (STEP 6b); or “PRESS OR SAY THREE IF YOU WANT TO RENEW YOUR SUBSCRIPTION/MEMBERSHIP FOR THREE YEARS FOR $200” (STEP 6c). Those skilled in the art will appreciate that these options are shown illustratively and that the IVR messages can be configured in a myriad of ways, all of which are included in the present disclosure.

Preferably, at any point during the IVR announcement of subscriber/member options (STEP 6a-6c), the subscriber/member can input or repeat the designated number, which the microprocessor will read and process (STEP 7). Preferably, the microprocessor will automatically update the subscriber/member's account information (STEP 8) and will issue an invoice for the cost of the renewal (STEP 9). For example, if the subscriber/member enters or repeats the number ONE, the microprocessor will cause the subscriber/member's account information to be updated to reflect a one-year extension to the subscriber/member's subscription or membership (STEP 8) and an invoice for $100 will be mailed to the subscriber/member (STEP 9). Similarly, if the subscriber/member enters or repeats the number TWO, the microprocessor will cause the subscriber/member's account information to be updated to reflect a two-year extension to the subscriber/member's subscription or membership (STEP 8) and an invoice for $150 will be mailed to the subscriber/member (STEP 9), and so forth.

More preferably, instead of invoicing the subscriber/member directly, the microprocessor can execute another application that will communicate the cost of the renewal to the telecommunication service provider associated with the origination telephone number and the amount will be included in the subscriber/member's next telephone billing statement (STEP 10). For example, if the subscriber/member's local or long distance telephone carrier is Verizon®, then the microprocessor will communicate the $100, $150, or $200 amount to Verizon® and on the subscriber/member's next monthly billing statement, the amount and renewal information will be included. Advantageously, the business would not have to go to the expense of invoicing the subscriber/member directly and also would not have to go to the expense of employing countless persons to sort through a multiplicity of incoming small dollar amount payments; rather, instead, a single payment from Verizon® and all of the other local or long distance telephone carriers, reflecting the payments of a multiplicity of subscribers/members, will be processed. Here again, although this embodiment of the present technology refers to the subscriber/member and his or her local or long distance telephone carrier, the present technology is not to be construed as being limited thereto. Indeed, for invoicing purposes, the cost for applying for or renewing a subscription of membership can appear on any billing means that invoices subscribers/members periodically, e.g., Internet Service Providers, cable providers, and the like.

Not all local or long distance telephone carriers, however, may accept this method of payment. For those carriers that do not or will not invoice their customers in accordance with the teachings of this present technology, the origination telephone numbers of the subscriber/members that are their customers will be “blocked” as mentioned above. As a result, those persons will be identified early on in the process, e.g., at STEP 3, and the business will invoice the subscriber/members directly (STEP 9).

The myriad of databases used in the embodied method also can enable the businesses to track and monitor their renewal efforts. For example, periodic reports, e.g., daily, weekly, monthly, and the like, can be provided to the microprocessor or any other digital electronic devices that is networked with the microprocessor. This information and these reports can be communicated by LAN, WAN, wireless radio, the Internet, T1, T2, and the like. For example, daily reports can provide the number and/or names of subscribers/members who renewed; weekly reports can compile the numbers and/or names from daily reports and send renewal confirmation letters to the subscribers/members; and monthly reports can compile the numbers and/or names from weekly reports, which can be used in conjunction with subscriber/member or long distance telephone carrier payment information. Period reporting can also include lists of subscriber/members whose subscription or membership has expired or is due to expire in the near future so that the business can initiate the renewal method described hereinabove.

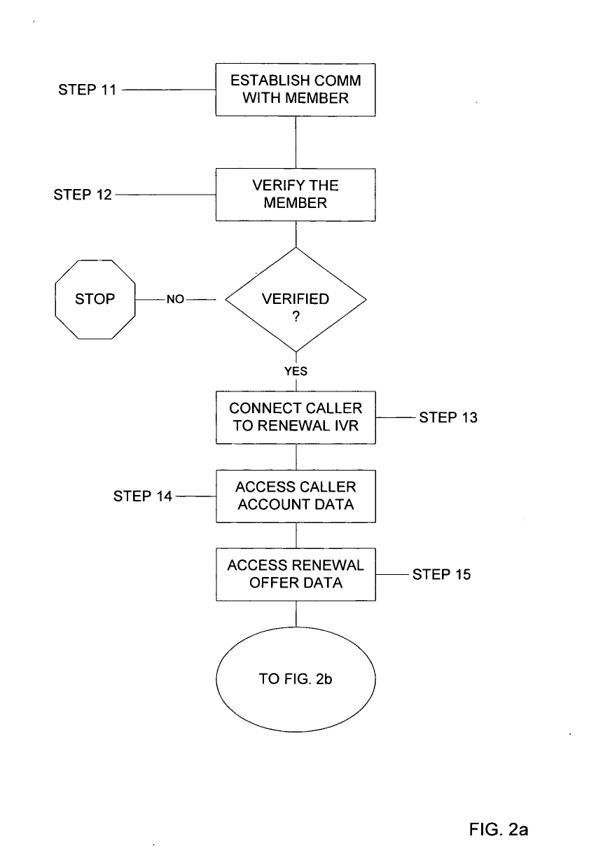

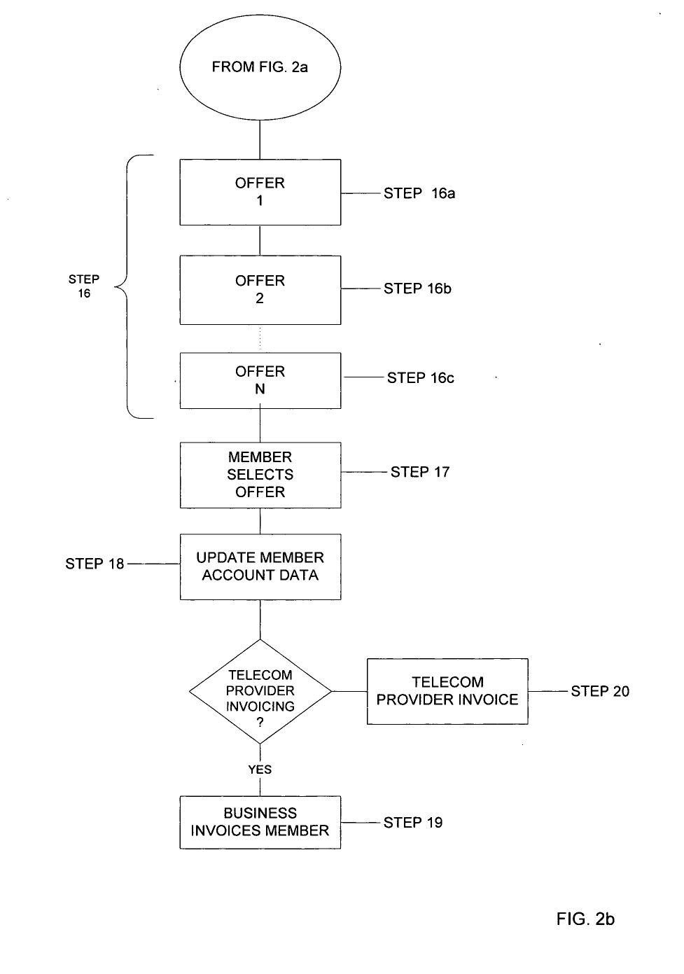

Referring to FIGS. 2a and 2b, a method of renewing subscriptions or memberships when the business establishes the communication link will now be described. In a preferred embodiment of a business (or a third party) initiated renewal, the steps of identifying and verifying the caller through the origination telephone number are not necessary and whether or not the subscriber/member's telephone number is “blocked” can be determined as previously described before the business established a communication link with the subscriber/member (STEP 11). Preferably, all subscribers/members whose destination telephone number is “blocked” for reasons other than those having to do with their local or long distance telephone carrier, will not be called at all and only those whose destination telephone number is blocked because of their local or long distance telephone carrier can be called. Once communication with the subscriber/member is established (STEP 11), an IVR message can verify that the person on the telephone is the subscriber/member (STEP 12), e.g. by requiring the person to enter manually or vocally some personal information, e.g., one or more of a PIN, all or some portion of a social security number, a zip code, a mother's maiden name, and the like. STEPS 13-20 of the second embodiment are identical to STEPS 4-10 of the first embodiment, which are described above and will not be repeated.

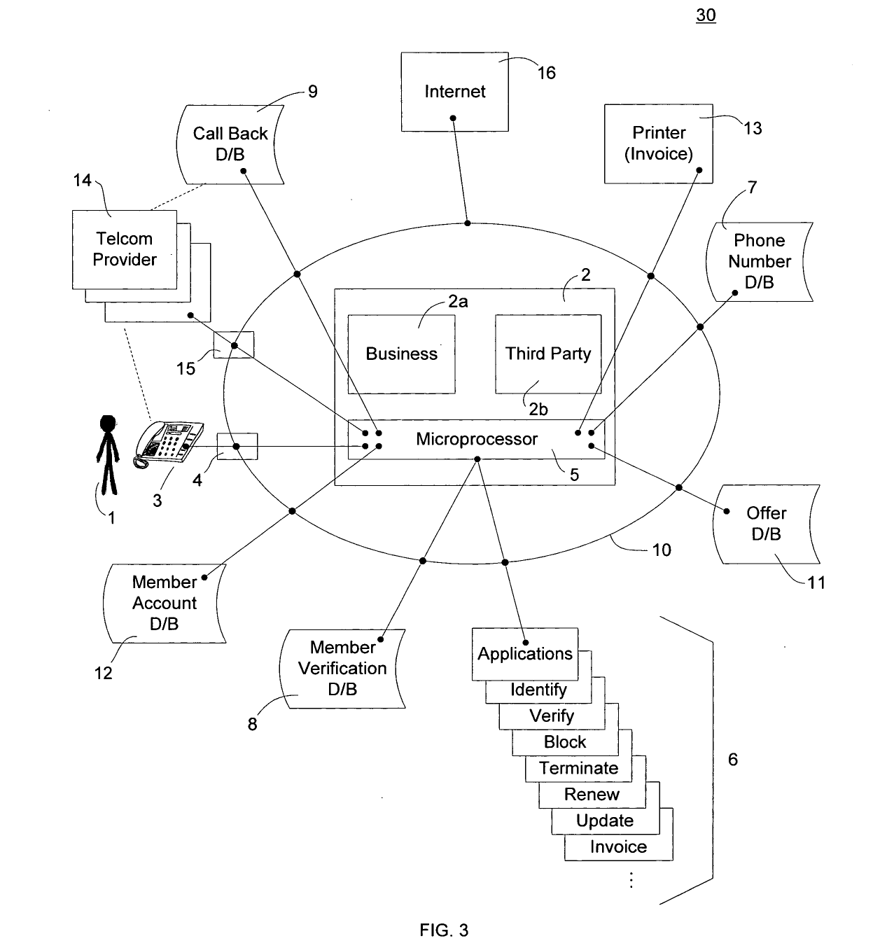

Having described embodiments of two methods, we will now describe systems for applying for and/or renewing subscriptions or memberships over a telecommunication network. Referring to FIG. 3, there is shown a preferred embodiment of such a system 30. Preferably, the system 30 comprises a communication network 10 and an electronic device 5, e.g., a microprocessor 5, to control the operation of the system 30 and execution of the process steps described in the previous embodiments. Preferably, the subscriber/member 1 can establish or initiate the communication network 10 or, alternatively, a business 2a and/or a third party 2b can. In one aspect of the embodied system 30, the subscriber/member 1 establishes the communication network 10 by calling a pre-designated telephone number that has been made known to the subscriber/member 1, e.g., through advertising, a letter, a flyer, an electronic mail message, and the like. Preferably, the subscriber/member 1 can establish the communication link 10 with the business 2a using a hardwired or wireless telephone 3. More preferably, the subscriber/member 1 can establish a communication link 10 with the business 2a over a PSTN. Although this disclosure will refer to the subscriber/member 1 calling a business 2a, in the alternative, the subscriber/member 1 can call a third party 2b that is being used by the business 2a.

Preferably, the business 2 includes one or more local or remote microprocessor 5 that is in communication with designated telephone number of the business 2 and the caller 1. More preferably, the microprocessor 5 is capable of identifying the caller and verifying that the caller is a subscriber/member 1 of the business 2. For example, the microprocessor 5 can include a plurality of applications 6, e.g., software and/or executable programs, that can identify the telephone number from which the call originated and compare the origination telephone number with a database of subscriber/member telephone numbers 7. If the origination telephone number does not coincide with any subscriber/member telephone numbers in the database 7 then the microprocessor 5 can terminate the call. Optionally, the microprocessor 5 can run another application 6 to initiate an interactive voice recording (“IVR”) requesting the subscriber/member 1 to enter some personal information about himself or herself that can be compared with subscriber/member data stored in another database 8 to identify the caller as a subscriber/member 1.

Once the microprocessor 5 verifies that the caller is a subscriber/member 1, the microprocessor 5 includes another application 6 that ascertains whether or not the subscriber/member 1 is included on a database 9 of subscriber/members who the business 2 wants to block from applying for or renewing a membership or subscription. Preferably, the blocking database 9 includes the telephone numbers of subscriber/member's whose local or long distance telephone carrier will not include the cost of any renewal on the subscriber/member's monthly telephone billing statement.

In another aspect of the embodied system, the microprocessor 5 includes another application 6 that will connect the subscriber/member to a subscription or membership application or renewal IVR. Preferably, the application 6 also can access a database 12 containing information about the subscriber/member's account, e.g., expiration date, address, personal information, and the like. More preferably, the application 6 can access a database 11 that contains information about offers and discounts that the subscriber/member 1 may be entitled to.

In a preferred embodiment, the IVR application 6 can provide any number of application or renewal options to the subscriber/member 1. For example, the IVR could request that the subscriber/member “PRESS OR SAY ONE IF YOU WANT TO RENEW YOUR SUBSCRIPTION/MEMBERSHIP FOR ONE YEAR FOR $100”; or “PRESS OR SAY TWO IF YOU WANT TO RENEW YOUR SUBSCRIPTION/MEMBERSHIP FOR TWO YEARS FOR $150”; or “PRESS OR SAY THREE IF YOU WANT TO RENEW YOUR SUBSCRIPTION/MEMBERSHIP FOR THREE YEARS FOR $200”.

In another aspect of a preferred embodiment of the present system, the system 30 further comprises a device 3 for the subscriber/member 1 to enter his or her application or renewal options, e.g., a telecommunication device such as a hardwired telephone unit or wireless telephone unit; and a device 4 or application 6 for the microprocessor 5 to read and process the subscriber/member's manual or vocal entries. In a preferred embodiment the device 4 is an interface between the microprocessor 5 and the telecommunication device 3 that is capable of “reading” digital tones and/or vocal entries an, moreover, can provide these data to the microprocessor 5 in a machine readable, e.g., digital, format.

Preferably, the device can automatically record or update the subscriber/member's account information in the account database 12 and, more preferably, includes an invoice device 13, e.g., a printer, to prepare and issue an invoice for the cost of the renewal. For example, if the subscriber/member 1 enters or repeats the number ONE, the microprocessor 5 will cause the subscriber/member's account 13 information to be updated to reflect a one-year extension to the subscriber/member's subscription or membership and an invoice for $100 will be produced by the invoice device 13 and the invoice mailed to the subscriber/member 1. Similarly, if the subscriber/member 1 enters or repeats the number TWO, the microprocessor 5 will cause the subscriber/member's account information 13 to be updated to reflect a two-year extension to the subscriber/member's subscription or membership and an invoice for $150 will be produced by the invoice device 13 and an invoice mailed to the subscriber/member 1.

More preferably, instead of invoicing the subscriber/member 1 directly, the system 30 and microprocessor 5 can include internally or be in communication with an interface 15 to communicate the cost of the renewal to the telecommunication service provider 14 associated with the origination telephone number and the amount will be included in the subscriber/member's next telephone billing statement. For example, if the subscriber/member's long distance telephone carrier is a telecom provider 14, then the microprocessor will communicate the $100, $150, or $200 renewal fee amount to the telecom provider 14 and on the subscriber/member's next monthly billing statement, the amount and renewal information will be included. Advantageously, the business 2 would not have to go to the expense of invoicing the subscriber/member 1 directly and also would not have to go to the expense of employing countless persons to sort through a multiplicity of incoming payments. Instead, a single payment from the telecom provider 14 and any of the other long distance telephone carriers 14, reflecting the payments of a multiplicity of subscribers/members 1, can be processed in gross. Here again, although this embodiment of the present technology refers to the subscriber/member and his or her local or long distance telephone carrier, the present technology is not to be construed as being limited thereto. Indeed, for invoicing purposes, the cost for applying for or renewing a subscription of membership can appear on any billing means that invoices subscribers/members periodically, e.g., Internet Service Providers, cable providers, and the like.

Although preferred embodiments of the present technology have been described using specific terms, such descriptions are for illustrative purposes only, and it is to be understood that changes and variations may be made without departing from the spirit or scope of the invention. For example, although the specification has been written referring to renewal of subscriptions and/or memberships, it is not to be construed as being limited thereto. For example, instead of renewing subscriptions and memberships, the teachings of this present technology also include, without limitation, signing up for an event, e.g., a participative sporting event like the Boston Marathon or lesser-known foot race.

Although the electronic device for controlling the present technology has been described as a microprocessor, this is not to say that more than one microprocessors cannot be used instead of just a single unit. Similarly, the electronic device can also include, without limitation, a computer or a serving engine. Likewise, the plurality of databases described above can be provided locally or remotely on or in the same or separate memories, i.e., read only memories.

Furthermore, in another aspect of the present technology, the communication network can also include an interface onto the Internet or other World Wide Web network. In this way, data stored in the plurality of databases can be provided for use or transmission over the Internet.

While the invention has been described with respect to preferred embodiments, those skilled in the art will readily appreciate that various changes and/or modifications can be made to the invention without departing from the spirit or scope of the invention as defined by the appended claims.

What is claimed is:

1. A method of applying for or renewing a subscription or membership over a telecommunication network, the steps of the method comprising:
establishing communication between a calling member and a business offering the subscription or membership or a third party;
verifying the identity of the member;
providing the member with a plurality of subscription or renewal options from which said member must choose a preferred subscription or renewal option; and
processing the member's preferred subscription or renewal option.

2. The method as recited in claim 1, wherein the option is selected from the group consisting of a subscription option, a renewal option and combinations thereof.

3. The method as recited in claim 1, wherein the step of processing the member's preferred option includes updating an expiration date of the member.

4. The method as recited in claim 1, wherein the step of processing the member's preferred option includes recording an expiration date of the member.

5. The method as recited in claim 1, wherein the step of processing the member's preferred option includes providing the member with an invoice.

6. The method as recited in claim 5, wherein the step of providing the member with an invoice comprises including an amount of the application on a monthly billing statement from a telephone carrier used by the member.

7. A method of applying for or renewing a subscription or membership over a telecommunication network, the steps of the method comprising:
establishing communication between a calling business offering the membership and a subscriber;
verifying the identity of the subscriber;
providing the subscriber with a plurality of options from which said subscriber must choose a preferred option; and
processing the subscriber's preferred option.

8. The method as recited in claim 7, wherein the step of processing the subscriber's preferred option includes updating an expiration date of the subscriber's membership.

9. The method as recited in claim 7, wherein the step of processing the subscriber/member's preferred subscription or renewal option includes providing the subscriber/member with an invoice in an amount of the application or renewal.

10. The method as recited in claim 9, wherein the step of providing the subscriber/member with an invoice comprises including the amount of the application or renewal on a monthly billing statement from a local or long distance telephone carrier used by the subscriber/member.

11. A system for applying for or renewing subscriptions or memberships over a telecommunication network, wherein the system comprises:
an electronic control device having a plurality of executable applications and having access to data from at least one database for establishing communication with a member over the telecommunication network;
an interactive voice recording system that provides at least one subscription or membership application or renewal option to the member via the telecommunication network; and
a processing means to process the at least one subscription or membership application or renewal option entry provided by the member.

12. The system as recited in claim 11, wherein the processing means includes means to update an expiration date of the member's subscription or membership.

13. The system as recited in claim 12, wherein the processing means provides the member with an invoice in an amount of the application or renewal.

14. The system as recited in claim 13, wherein the processing means provides the amount of the application or renewal on a monthly billing statement from a local or long distance telephone carrier used by the member.

15. The system as recited in claim 11, wherein the electronic control device is a computer with a processor and memory.

16. The system as recited in claim 11, wherein the interactive voice recording system is a computer with a processor and memory.

17. The system as recited in claim 11, wherein the processing means is a computer with a processor and memory.
